(19) United States
(12) Patent Application Publication
(10) Pub. No.: US 2024/0338000 A1
(43) Pub. Date: Oct. 10, 2024

(54) METHODS FOR IN SITU CONTROL OF TINTED WINDOWS AND CONTROL APPARATUSES

(71) Applicant: CORNING INCORPORATED, CORNING, NY (US)

(72) Inventors: James Gregory Couillard, Ithaca, NY (US); Eric Michael Gross, Corning, NY (US); Dragan Pikula, Horseheads, NY (US)

(21) Appl. No.: 18/579,538

(22) PCT Filed: Jul. 13, 2022
(86) PCT No.: PCT/US2022/036903

§ 371 Date: Jan. 16, 2024

Related U.S. Application Data
(60) Provisional application No. 63/222,725, filed on Jul. 16, 2021.

(51) Int. Cl. G05B 19/042; A47H 5/02; E06B 9/24; E06B 9/38; G02F 1/137

(52) U.S. Cl. CPC G05B 19/042; E06B 9/24; G02F 1/137; A47H 5/02; A47H 2005/025; E06B 2009/2464; E06B 9/38; G05B 2219/23227

(57) ABSTRACT

Disclosed are methods and apparatuses for in situ control of smart or tinted windows. Also disclosed are methods and apparatuses for controlling at least one internal environmental condition for an interior space including at least one window.

### CROSS-REFERENCE TO RELATED APPLICATIONS

This application claims the benefit of priority under 35 U.S.C. § 119 of U.S. Provisional Application No. 63/222,725 filed Jul. 16, 2021, the content of which is incorporated herein by reference in its entirety.

### FIELD OF THE DISCLOSURE

The disclosure relates generally to methods for in situ control of tinted windows and apparatuses for implementing such control. More particularly, the disclosure relates to in situ control of smart windows, such as tintable liquid crystal windows, to improve at least one of illumination, glare, energy efficiency, and heat management in a room or building.

### BACKGROUND

Smart or tintable windows are windows capable of changing light transmission levels and/or solar heat gain coefficient (SHGC) in real time to improve the management of room illumination, glare discomfort, energy consumption, and heat management. Smart windows can be utilized in various architectural applications, such as windows, doors, skylights, and partitions in commercial or residential buildings. In some instances, smart windows can adjust light transmission by changing the tint level or another physical property of the window based on user input or predetermined setpoints. Light transmission can alternatively or additionally be altered by exterior and/or interior blinds, shades, or drapery.

A combination of the smart window tint states along with the intensity of the internal or artificial room lighting can be used to optimize visual comfort and energy usage by harvesting or blocking solar radiation. However, it can be difficult to precisely determine the appropriate combination of setpoints using current ad hoc or model-based methods. Modeled predictions can be useful but are subject to numerous assumptions that can limit their effectiveness. Additionally, solid-state electrochromic glass windows, which are currently used as smart windows, can be cost prohibitive and can have slow transition times between tint states, for example, 20 seconds or more and even up to 30 minutes depending on the window size and tint transition level.

As such, there is a need for a method for controlling smart windows that can provide improved setpoint determinations based on data gathered in situ as opposed to modeled or predictive data. It would also be advantageous to provide a method in which in situ data can be gathered and the setpoints correspondingly altered at an improved speed. It would further be advantageous to provide a control apparatus that is cost-effective and energy-efficient while also providing more precise setpoints for a larger combination of variable factor levels.

### SUMMARY

The disclosure relates to methods for controlling at least one environmental condition of an interior space comprising at least one window, the methods comprising: (a) receiving a first indication of at least one external environmental condition from at least one exterior sensor at a first timepoint; (b) receiving a second indication of the at least one external environmental condition from the at least one exterior sensor at a second timepoint; (c) determining a change in the at least one external environmental condition between the first timepoint and a second timepoint; (d) receiving an indication of at least one internal environmental condition in the interior space from at least one interior sensor at the second timepoint; (e) determining if the at least one internal environmental condition satisfies at least one predetermined constraint at the second timepoint; and (f) altering a light transmission of the at least one window using a control device configured to adjust at least one physical property of the at least one window to produce a setpoint, wherein the at least one internal environmental condition satisfies the at least one predetermined constraint at the setpoint.

According to various embodiments, the at least one window comprises a liquid crystal window and altering the light transmission of the at least one window comprises actuating at least one liquid crystal layer in the liquid crystal window. In non-limiting embodiments, the at least one control device adjusts a tint level, contrast level, or light scattering property of the at least one window. According to some embodiments, altering the light transmission of the at least one window can occur within an adjustment time period of 15 seconds or less, such as 1 second or less.

According to some embodiments, the at least one external environmental condition can be chosen from time of day, time of year, season, geographical position, sun position, sun intensity, cloudiness, fogginess, haze level, temperature, humidity, or combinations thereof. In additional embodiments, the at least one internal environmental condition can be chosen from illuminance, glare, room temperature, or combinations thereof. According to various embodiments, the method further comprises receiving a room occupancy indicator from the at least one interior sensor prior to altering the light transmission of the at least one window. In further embodiments, altering the light transmission of the at least one window occurs when the at least one interior sensor indicates that an occupancy of the interior space is less than or equal to a predetermined occupancy threshold.

According to non-limiting embodiments, altering the light transmission of the at least one window can comprise selecting a setpoint from stored setpoints determined at previous timepoints during external environmental conditions similar to the at least one external environmental condition determined at the second timepoint. In alternative embodiments, the method can comprise repeating steps (d)-(f) in situ for a predetermined time period to produce a plurality of possible setpoints and selecting an optimal setpoint corresponding to a maximum or minimum value of the at least one internal environmental condition. According to various embodiments, the method can further comprise adjusting at least one of a position of external or internal blinds, shades, or drapery; artificial light intensity; room temperature, or combinations thereof using at least one control device.

In still further embodiments, the at least one internal environmental condition comprises a first internal environmental condition and a second internal environmental condition, and the method further comprises: (g) altering at least one additional variable of the interior space using at least one control device to produce an overall setpoint, wherein the first internal environmental condition satisfies a first predetermined constraint and the second internal environmental condition satisfies a second predetermined constraint at the overall setpoint. In these non-limiting embodiments, the method can further comprise repeating steps (d)-(g) in situ for a predetermined time period to produce a plurality of possible setpoints and selecting an optimal setpoint corresponding to a maximum or minimum value of the first internal environmental condition, wherein the second internal environmental condition satisfies the second predetermined constraint at the optimal setpoint.

The disclosure also relates, in various embodiments, to apparatuses for controlling at least one environmental condition of an interior space, the apparatuses comprising: (a) at least one exterior sensor configured to determine at least one external environmental condition; (b) at least one interior sensor configured to determine at least one internal environmental condition; (c) a computer processor configured to receive data from the at least one exterior sensor and the at least one interior sensor and to determine at least one setpoint based on the received data; (d) at least one control device in communication with the computer processor and configured to receive the at least one setpoint and send a signal with adjustment instructions to at least one window in the interior space; and (e) at least one window configured to receive the signal and actuate upon receipt of the signal to adjust at least one physical property of the at least one window based on the adjustment instructions within an adjustment time period of 15 seconds or less. According to certain embodiments, the at least one window comprises a liquid crystal window. In additional embodiments, the adjustment time period is 1 second or less.

In non-limiting embodiments, the at least one exterior sensor is chosen from visible light sensors, infrared sensors, temperature sensors, humidity sensors, or combinations thereof. In additional embodiments, the at least one exterior sensor is in communication with a network, such as an internet or intranet network, and configured to retrieve data from the network regarding the at least one external environmental condition. The at least one interior sensor can, in some embodiments, be chosen from visible light sensors, infrared sensors, glare sensors, temperature sensors, humidity sensors, or combinations thereof. According to certain embodiments, the at least one interior sensor can comprise an occupancy sensor.

In further embodiments, the computer processor can be configured to store at least one predetermined constraint for the at least one internal environmental condition. According to various embodiments, the computer processor can be further configured to store at least one predetermined setpoint corresponding to a given external environmental condition. In yet further embodiments, the control device can be further configured to adjust at least one additional variable of the interior space, such as the position of external or internal blinds, shades, or drapery; artificial light intensity; room temperature; air flow; or combinations thereof.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework for understanding the nature and character of the claims. The accompanying drawings are included to provide a further understanding of the disclosure and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIGS. 1A-C depict schematic diagrams of rooms equipped with a control apparatus and comprising at least one smart window according to non-limiting embodiments of the disclosure;

FIGS. 2-3 depict flowcharts for in situ detection and control of smart windows according to various embodiments of the disclosure; and

FIGS. 4A-C depict cross sectional views of liquid crystal windows according to certain embodiments of the disclosure.

### DETAILED DESCRIPTION

Disclosed herein are methods for controlling at least one environmental condition of an interior space comprising at least one window, the methods comprising: (a) receiving a first indication of at least one external environmental condition from at least one exterior sensor at a first timepoint; (b) receiving a second indication of the at least one external environmental condition from the at least one exterior sensor at a second timepoint; (c) determining a change in the at least one external environmental condition between the first timepoint and a second timepoint; (d) receiving an indication of at least one internal environmental condition in the interior space from at least one interior sensor at the second timepoint; (e) determining if the at least one internal environmental condition satisfies at least one predetermined constraint at the second timepoint; and (f) altering a light transmission of the at least one window using a control device configured to adjust at least one physical property of the at least one window to produce a setpoint, wherein the at least one internal environmental condition satisfies the at least one predetermined constraint at the setpoint.

Also disclosed herein are apparatuses for controlling at least one environmental condition of an interior space, the apparatuses comprising: (a) at least one exterior sensor configured to determine at least one external environmental condition; (b) at least one interior sensor configured to determine at least one internal environmental condition; (c) a computer processor configured to receive data from the at least one exterior sensor and the at least one interior sensor and to determine at least one setpoint based on the received data; (d) at least one control device in communication with the computer processor and configured to receive the at least one setpoint and send a signal with adjustment instructions to at least one window in the interior space; and (e) at least one window configured to receive the signal and actuate upon receipt of the signal to adjust at least one physical property of the at least one window based on the adjustment instructions within an adjustment time period of 15 seconds or less. According to certain embodiments, the at least one window comprises a liquid crystal window.

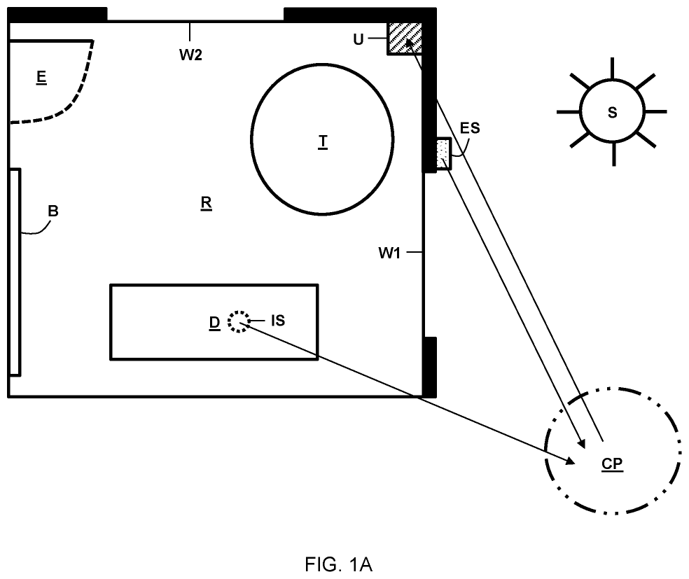

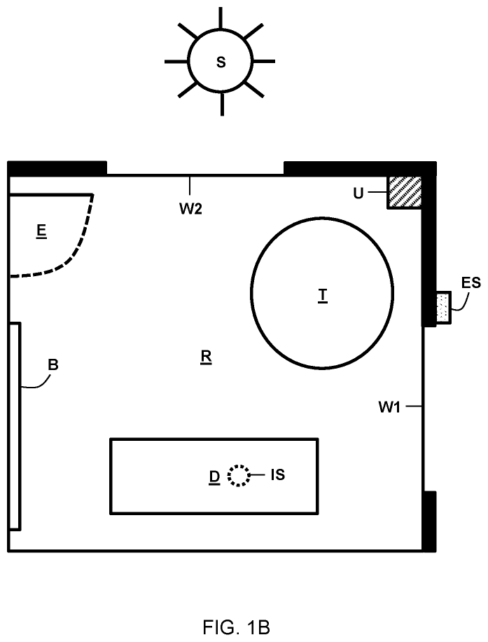

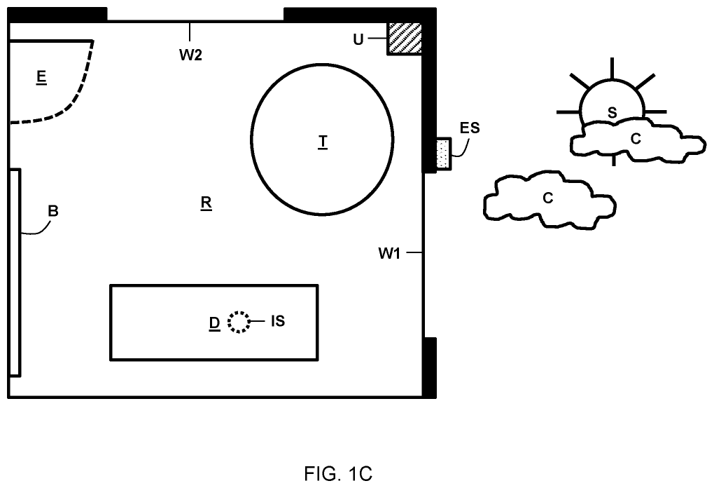

Embodiments of the disclosure will now be discussed with reference to FIGS. 1-4, which illustrate exemplary room schematics, control flow diagrams, and liquid crystal windows according to various aspects of the disclosure. The following general description is intended to provide an overview of the claimed methods and apparatuses, and various aspects will be more specifically discussed throughout the disclosure with reference to the non-limiting depicted embodiments, these embodiments being interchangeable with one another within the context of the disclosure.

### Apparatuses

Apparatuses for controlling at least one environmental condition of an interior space comprising at least one smart window will now be discussed with reference to FIGS. 1A-C. FIGS. 1A-C depict an interior space or room R comprising at least one smart or tintable window, e.g., first window W1 and second window W2. Interior space R is depicted as an office but can also, for example, be part of a commercial or residential building, such as a conference room or lobby in a commercial building, an apartment in a residential building, or a room in a residential home. Additionally, windows W1 and W2 are depicted as traditional windows but can be any transparent barrier separating the interior space from the external environment, such as a transparent door, skylight, wall of windows, or other partition. Additionally, interior space R can comprise only one smart window in certain embodiments or more than one smart window according to other embodiments and these windows may abut each other or may be separated by structural features such as wall panels, pillars, and the like. The interior space can have a single level (as depicted) or multiple levels (not depicted) and the smart windows may be on the same level or different levels. Further, interior space R can comprise only one exterior wall or more than one exterior wall, e.g., two exterior walls as depicted in FIGS. 1A-C, and the smart windows may be on the same exterior wall or different exterior walls.

Interior space R is equipped with an apparatus for controlling at least one internal environmental condition, for example, by adjusting the light transmission or tint of at least one of windows W1 and W2. While all components of the control apparatus may be located inside interior space R, it is also possible that one or more components of the control apparatus may be remotely positioned. In non-limiting embodiments, the apparatus can comprise at least one exterior sensor ES configured to sense, measure, or otherwise determine at least one external environmental condition. As used herein, the term “external” environmental condition is intended to refer to one or more conditions outside of the building in which interior space R is located.

While FIGS. 1A-C depict a single sensor ES adjacent to first window W1, it is to be understood that exterior sensor ES can be positioned in any location and/or more than one exterior sensor ES can be used. Furthermore, while exterior sensor ES is located outside of the interior space R, e.g., in contact with the external environment, it is to be understood that sensor(s) ES can also be located inside the interior space R, e.g., mounted to the interior-facing surface one or both of windows W1, W2. Alternatively, exterior sensor ES may not be physically present inside or outside of interior space R. For instance, sensor(s) ES may be located in a central building location or may comprise a wireless or wired hub for retrieving data from an online or offline network. The term “exterior” sensor is thus intended to denote that the sensor detects or determines a condition that is outside of the interior space and is not intended to be limiting in terms of physical location.

Exterior sensors ES can include, in non-limiting embodiments, visible light sensors, infrared sensors, temperature sensors, humidity sensors, and combinations thereof. In some embodiments, the exterior sensor ES can be configured to retrieve data from an online or internet network regarding one or more external environmental conditions. The exterior sensor ES can also be configured to retrieve or receive data from an offline or standalone network, such as an intranet or computer network or a building management system (BMS). Examples of external environmental conditions can include, but are not limited to, time of the day, time of year (date), season, geographic location, sun position, sun intensity, cloudiness, fogginess, haze level, temperature, or humidity, to name a few. For instance, FIG. 1A depicts an external environmental condition wherein the sun S is unobstructed by clouds and in a position proximate to first window W1. FIG. 1B depicts a different external environmental condition wherein the sun S is unobstructed by clouds but in a different position proximate to second window W2. Sun position can be affected, e.g., by time of day or time of year, etc. FIG. 1C depicts a different external environmental condition wherein the sun S is partially obstructed by clouds C. Changes in external environmental conditions can either be sensed directly by exterior sensors ES or can be determined from other available information, such as online weather reports and/or radar images, or offline data gathered from a local network.

In various embodiments, the apparatus can also comprise at least one interior sensor IS configured to sense, measure, or otherwise determine at least one internal environmental condition. As used herein, the term “internal” environmental condition is intended to refer to one or more conditions inside the interior space R. While FIGS. 1A-C depict a single sensor IS proximate the desk D, it is to be understood that interior sensor(s) IS can be positioned in any location within interior space R and/or more than one interior sensor IS can be used. For example, interior sensor(s) IS can be located proximate to conference table T and/or white board or display screen B, entryway E, or any other location or combination of locations.

Non-limiting examples of interior sensors IS can include visible light sensors (such as a lux meter), infrared sensors, glare sensors, temperature sensors, humidity sensors, or combinations thereof. Internal environmental conditions can include, but are not limited to, illuminance levels, glare levels, room temperature, thermal comfort, and combinations thereof.

As used herein, “illuminance” is intended to refer to the amount of light measured in a plane surface or the total luminous flux incident on a surface per unit area. Illuminance can be measured in units of lux or foot-candles. Office areas can typically have an illuminance of about 400 to 500 lux, with a minimum of about 320 lux as specified by the Occupational Safety and Health Administration (OSHA). A general office area illuminance level may range between about 300 lux to about 600 lux. However, precision work areas may need higher illumination, such as 800 lux or more. Other areas, such as storage facilities or areas of little or no occupancy may maintain a lower illuminance level, such as 200 lux or lower. As such, the desired illuminance level can vary depending on the targeted area. According to various embodiments, the illuminance level can range from about 100 lux to about 1200 lux, from about 200 lux to about 1100 lux, from about 300 lux to about 1000 lux, from about 400 lux to about 900 lux, from about 500 lux to about 800 lux, or from about 600 lux to about 700 lux, including all ranges and subranges therebetween.

As used herein, “glare” is intended to refer to discomfort or disability caused by light reflecting from a surface or otherwise covering a visual task. Glare reduces the image contrast and can make a user less able to discriminate what is being viewed. Direct glare or disability glare is light that directly enters the user's eye, such as by staring at the sun or other light source. Indirect glare or discomfort glare can be caused by high ambient light, such as from intense overhead lighting or excessive light transmission through windows. Glare can be measured using a visible light sensor such as a lux meter located at a position and orientation similar to that of the desired room occupant. However, such a measurement can, in certain instances, be impractical. Algorithms for determining glare or visual comfort can also be used, which are primarily based on the ambient light, occupant position, and solid angle of the light source. Exemplary algorithms are described in Carlucci et al., “A review of indices for assessing visual comfort with a view to their use in optimization processes to support building integrated design,” Renewable and Sustainable Energy Reviews, vol. 47, pp. 1016-1033 (2015).

Data from a lux meter or other interior sensor inside a given area can be transmitted to a control system that can calculate a glare index for a general occupant in a specified location of the area, such as the center of a room, a seating area, display area, and so forth. The solid angle of the light source, e.g., light entering through one or more windows, can be calculated for the given location and saved as a constant for the glare index calculation. A controller, room occupant, or building manager can set a maximum discomfort glare index (DGI) for a given area as a control constraint. Once the DGI is above the maximum threshold, one or more properties of the window(s) in the area can be adjusted using the methods and apparatuses disclosed herein to reduce the glare index to within acceptable values. Exemplary but non-limiting DGI values are less than or equal to about 22, such as less than or equal to about 20, less than or equal to about 18, or less than or equal to about 16, including all ranges and subranges therebetween. In some embodiments, the glare level within a specified area can range from about 15≤DGI≤25.

Room temperature or ambient temperature refers to the average temperature across a given space and can be measured, e.g., by a thermometer, thermostat, or other like device. A desired room temperature can be targeted by a controller, room occupant, or building manager to a specified range with upper and lower temperature constraints. Exemplary room temperatures can range, for instance, from about 15° C. to about 30° C., such as from about 18° C. to about 28° C., from about 20° C. to about 26° C., from about 22° C. to about 24° C., including all ranges and subranges therebetween. Of course, it may be desirable to maintain lower temperatures, e.g., less than 15° C., for some rooms or spaces, such as storage facilities or computer networking spaces. Similarly, other rooms or spaces may benefit from higher temperatures, e.g., greater than 30° C. In some non-limiting embodiments, the room temperature may range from about 0° C. to about 40° C.

Thermal comfort more broadly refers to the comfort of room occupants and may take into account not only room temperature but also humidity. There are various algorithms for estimating thermal comfort. As a non-limiting example, the ASHRAE 55 standard is widely used and expresses thermal comfort as a percent of people dissatisfied (PPD) with the room environment. This standard primarily relies on calculations based on ambient temperature and humidity, but additional factors such as clothing (e.g., thickness, weight, coverage), air velocity, and activity level are also factored in. In an exemplary implementation, data from internal sensors regarding room temperature and humidity can be transmitted to a control system that can calculate PPD according to the ASHRAE 55 standard or any other acceptable standard. Assumptions regarding clothing and activity level could be made based on the location. Data regarding air velocity could also optionally be gathered from an internal sensor. A controller, room occupant, or building manager can set a maximum PPD for a given area as a control constraint. Once the PPD is above a maximum threshold, one or more properties of the window(s) in the area can be adjusted using the methods and apparatuses disclosed herein to adjust PPD to within acceptable values. By way of non-limiting example, a control algorithm could attempt to maintain PPD at less than or equal to about 20%, such as less than or equal to about 15%, less than or equal to about 10%, or less than or equal to about 5%, including all ranges and subranges therebetween.

In certain embodiments, interior space R can include at least one interior sensor IS capable of detecting room occupancy, e.g., whether the room is empty or not and/or how many occupants are in the room. According to various embodiments, the interior sensor IS can comprise a motion detector, biometric sensor, thermal sensor, or the like. As such, the apparatus can, in some embodiments, detect whether interior space R is occupied prior to initiating setpoint adjustments and/or mapping potential setpoints for a given external environmental condition. For example, the apparatus may not automatically function when the room is occupied or when the room occupancy is above a predetermined threshold. Of course, the apparatus may be manually overridden and prompted to run by a user regardless of room occupancy in some embodiments.

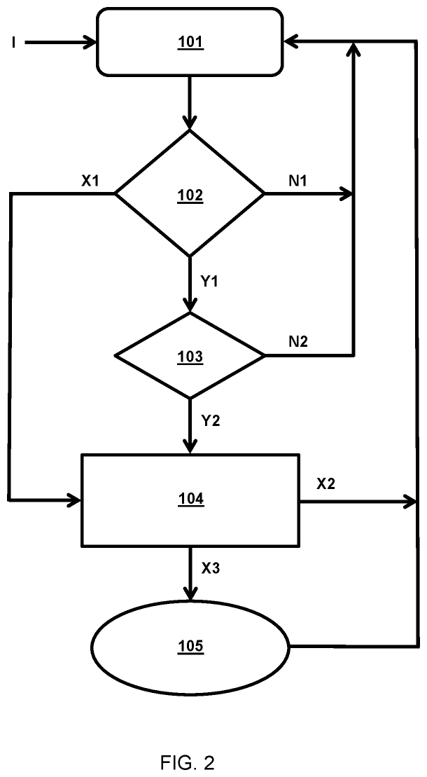

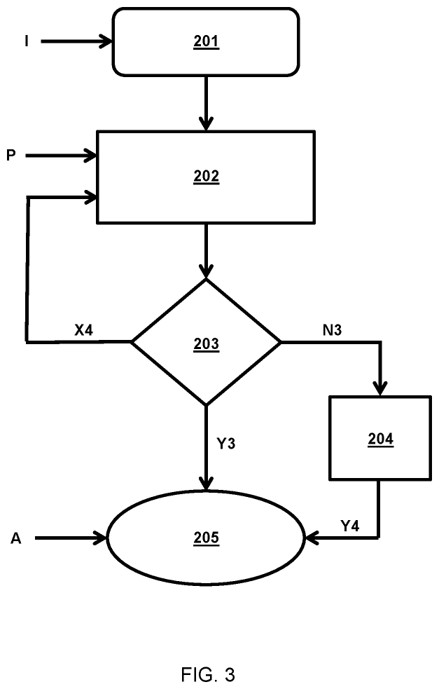

According to further embodiments, the apparatus comprises a computer readable program and/or computer processor CP in communication with the interior sensor(s) IS, the exterior sensor(s) ES, and the control device U. In additional embodiments, the computer processor CP can receive and/or store data from sensor(s) IS, ES and may also determine one or more setpoints based on the data received from these sensors. The computer processor CP may also transmit setpoint(s) to the control device U and store any setpoint(s) sent to the control device U. As used herein, the term “setpoint” is intended to refer to a set of parameters transmitted to the control device U that determine the level of light transmission through the smart window, e.g., the level of tinting, contrast, light scattering, etc. appropriate for a given external environmental condition. An overall setpoint can also be used to refer to the parameters for light transmission through the smart window in combination with one or more additional variables of the interior space, such as artificial lighting level, positioning of shades, blinds, or drapery, and heating or cooling settings, to name a few, as discussed in more detail below with reference to FIGS. 2-3.

The computer processor CP may be located outside of interior space R as depicted in FIG. 1A, such as in a central building location or may comprise a wireless or wired hub for storing and retrieving data. The computer processor CP can also, in alternative embodiments, be located within interior space R. The computer processor CP can, in some embodiments, be configured to store and retrieve at least one predetermined constraint for at least one internal environmental condition. As used herein the term “constraint” is intended to refer to a value or range of values determined by a user, such as a building occupant or manager, to be acceptable for a given internal environmental condition. For example, the user might provide a range of acceptable illuminance values, a maximum glare level, or a maximum or minimum room temperature, to name a few.

The computer processor CP may also be capable of producing a full or fractional factorial experiment design model over a period of time to identify the mapping of setpoints for internal environmental conditions as they relate to varying external environmental conditions. According to various embodiments, the computer processor CP may employ the design and thereby determine a model that relates one or more external conditions to one or more responses (e.g., glare, illumination, etc.) as a function of setpoints. The computer processor CP may also be capable of storing and/or retrieving one or more subsets of historical or previously mapped setpoints that produce an internal environmental condition meeting the predetermined constraints for a given external environmental condition. Over time, the CP can create a look up table such that if similar conditions are encountered in the future, the stored setpoints can be accessed and applied. Not every set of conditions under every set of environmental states can be tested; however, the design model can enable interpolation between prior recorded conditions to determine one or more setpoints that are likely to be acceptable for the current condition. The stored setpoints can be retrieved by the computer processor CP and transmitted to the control device U.

In further embodiments, the apparatus additionally comprises at least one control device or control unit U, such as an actuator, configured to adjust at least one physical property of the at least one smart window based on the setpoint(s) received from the computer processor CP. While FIGS. 1A-C depict a single control device U located between first window W1 and second window W2, it is to be understood that control device U can be positioned in any location and/or more than one control device U can be used. For example, each window W1, W2 could have a separate control device according to various embodiments. In the case of multiple windows, one or more control devices U can be used to send the same or different adjustment instructions to the windows. For instance, a single control device U, such as an actuator can adjust the light transmission of both windows W1, W2 to the same level, or a first control device can adjust the light transmission of window W1 to a first level and a second control device can adjust the light transmission of window W2 to a second level that is the same or different from the first level of window W1.

While control device U is depicted as located inside of the interior space R, it is to be understood that control device U may not be physically present inside of interior space R. For instance, control device U may be located in a central building location or may comprise a wireless or wired hub for receiving and transmitting data. Additionally, a single control device U can be used to control and adjust windows in more than one room. For example, a building may comprise several zones comprising a plurality of windows, such as windows facing the same direction or windows on the same level of the building, etc. Each zone may be controlled or adjusted by an individual control device U, which can be located anywhere within or in proximity to the building. Furthermore, the control device(s) U may control only the light transmission of the smart windows or, in alternative embodiments, the control device(s) U can also control other variables of the interior space, such as artificial lighting, heating and cooling, window treatments such as blinds, shades, and drapery, and/or motion sensing.

According to non-limiting embodiments, the control device U can comprise a modulator (not depicted) in communication with the computer processor CP and can be configured to receive at least one setpoint from the processor. The modulator can convert the setpoint into adjustment instructions that are then transmitted to the at least one window, e.g., windows W1 and/or W2. In the case of liquid crystal windows, which are discussed in more detail below, the control device U can send an electrical signal to a power source connected to one or more electrodes in the liquid crystal window. The electrodes can then send an electric field through one or more liquid crystal layers in the window. As discussed in more detail below, the applied electric field can affect the orientation of the liquid crystals, thereby providing different transmission states or tint levels. In the case of electrochromic windows, the control device can send an electrical signal to a power source connected to one or more electrochromic layers or regions of the window. The applied electrical current can alter the transparency of the electrochromic layer or region to produce different transmission states or tint levels.

While the methods and apparatuses disclosed herein can be used to control the light transmission of any type of smart window, it is noted that the transition speeds for liquid crystal windows is markedly faster than that of electrochromic windows, thereby requiring shorter adjustment time periods. While liquid crystal states can be switched in as little as 1 second or less, electrochromic windows typically need at least 20 seconds to switch and can take up to 30 minutes or more depending on the size of the window and the desired transmission level. The switching speed advantage of liquid crystal windows makes it an attractive choice for running in situ designed experiments to map setpoints, under certain environmental conditions, to responses. Furthermore, liquid crystal windows comprising multiple liquid crystal layers can provide a number of different tint states comparable to those achieved by electrochromic windows at a fraction of the cost.

As used herein the “adjustment time period” refers to the time period needed for the window to switch from one state to a new state upon receipt of adjustment instructions. A higher switching speed results in a shorter adjustment time period. In the case of liquid crystal windows, the adjustment time period can be less than about 15 seconds, such as less than about 10 seconds, less than about 5 seconds, less than about 4 seconds, less than about 3 seconds, less than about 2 seconds, less than about 1 second, or less than about 0.5 seconds, including all ranges and subranges therebetween. In certain embodiments, the adjustment time period can range from about 0.1 seconds to about 15 seconds, from about 0.3 seconds to about 10 seconds, from about 0.5 seconds to about 5 seconds, from about 1 seconds to about 4 seconds, or from about 2 seconds to about 3 seconds, including all ranges and subranges therebetween.

### Methods

Methods for in situ or “real time” control of at least one environmental condition of an interior space comprising at least one smart window will now be discussed with reference to FIGS. 2-3. As shown in the flowchart depicted in FIG. 2, the process can be initiated by gathering external input I in step 101 from one or more exterior sensors regarding at least one external environmental condition at a given timepoint. Such input I can include, but is not limited to, time of the day, time of year, season, geographic location, sun position, sun intensity, cloudiness, fogginess, haze level, or humidity, to name a few. In some embodiments, step 101 can include directly sensing one or more external environmental conditions, determining such information from online information, such as weather forecasts or radar images, or gathering information from other sources such as an intranet or computer network that may be associated with the interior space or building. Once the desired external input I is gathered, it can be analyzed in step 102 to determine if the external environmental conditions from the input received at the later (or second) timepoint is different from the conditions reported at the earlier (or first) timepoint. If so (yes), the process proceeds via Y1 to optional step 103 or via X1 to step 104. If not (no), the process returns via N1 to step 101 for additional external input gathering at a future timepoint.

The interval between measurement timepoints, e.g., first and second timepoints, can vary depending on the application. For instance, during setpoint mapping, the interval between timepoints may be relatively short to allow the system to attempt and map as many setpoints as possible in a given time period. During setpoint mapping, the difference between time points can be less than 1 minute, such as less than 30 seconds, less than 20 seconds, less than 10 seconds, less than 5 seconds, or as little as 1 second. Of course, it is also possible to perform setpoint mapping at longer intervals, such as every minute, every 5 minutes, every 10 minutes, every 20 minutes, every 30 minutes, every hour, every 3 hours, every 6 hours, every 12 hours, once per day, once per week, and so forth. During regular building occupancy, the interval between timepoints may be longer. For instance, a building manager, occupant, or BMS can schedule an interval at every 30 minutes, every hour, every 3 hours, and so forth. Of course, the apparatuses disclosed herein can also be manually overridden to provide any desired interval between measurement timepoints, e.g., the interval may be less than 30 minutes, such as less than 20 minutes, less than 10 minutes, less than 5 minutes, less than 1 minute, less than 30 seconds, less than 20 seconds, less than 10 seconds, less than 5 seconds, or as little as 1 second intervals.

In step 103, the interior space or room can be analyzed to determine if the occupancy is below a predetermined threshold. For example, a motion sensor, biometric sensor, or other occupancy sensing device can be used to determine if there are any occupants in the interior space and/or how many occupants there are. In some embodiments, the process will only proceed via Y2 if the occupancy level is below the predetermined threshold. If not (no), the process returns via N2 to step 101 for additional external input gathering. However, it is to be understood that occupancy sensing step 103 is optional and the process can proceed from step 102 directly to step 104 via X1 regardless of room occupancy in certain embodiments.

Step 104 comprises the in situ identification of a setpoint or a plurality of setpoints meeting at least one predetermined constraint for the interior space. During step 104 one or more internal environmental conditions can be sensed, measured, or otherwise determined. The value(s) for these condition(s) can then be compared against a predetermined range of acceptable conditions. If the value determined in situ for the at least one environmental condition does not meet the specified constraint(s), one or more physical properties of the smart window in the interior space can be adjusted to alter the light transmission through the smart window. For example, internal environmental conditions can include, but are not limited to, illuminance, glare, room temperature, thermal comfort, and combinations thereof.

A user, such as a room occupant or building manager, can set predetermined constraints or acceptable value ranges for one or more internal environmental conditions. When in situ sensing or measurement indicates that one or more of these values do not meet the predetermined constraints, the smart window(s) in the interior space or room can be adjusted as needed to correct or mitigate the issue. For example, if there is excessive glare in a given location within the interior space, the smart window(s) can be adjusted to increase the tint and thus decrease the light transmission through the smart window(s). Similarly, if the illuminance in the room is not sufficient, the smart window(s) can be adjusted to decrease the tint and thus increase the light transmission through the smart window(s). The revised setpoint(s) can either be chosen from historically or previously mapped setpoints for similar external environmental conditions or can be generated by repeating two or more iterations of adjustments and internal measurements until the constraint is met. Constraints might not be always achievable for all possible environmental conditions, but in this situation the algorithm can seek to satisfy the constraints as closely as possible as defined by minimizing the difference between the in situ condition and the constraint boundaries.

Following any adjustments, if necessary, the process can proceed via X2 back to step 101 for additional external input gathering. Alternatively, the process can proceed via X3 to optimization step 105. In optimization step 105, a narrower subset of setpoints can be chosen based on secondary criteria. For example, among a given number of potential setpoints, a narrower subset may be more energy efficient or may improve occupant comfort. In optimization step 105, auxiliary building systems may be altered to compensate for any adjustments made to the smart window(s), e.g., the heating or cooling load may be reduced, the artificial lighting in the interior space may be dimmed, window treatments such as shades or drapery can be fully or partially opened or closed, window treatments such as blinds can be adjusted to a different tilt position, and other like modifications. The optimization step 105 can thus produce an overall setpoint that includes not only a setpoint for the window tint level but also one or more setpoints for additional variables affecting the energy and/or thermal efficiency of the interior space or building.

Energy consumption can be broadly defined as the power being used by a room, interior space, or building at any particular moment in time. Primary drivers for energy consumption by a building include heating, cooling, air handling, and artificial lighting, to name a few. Energy consumption can be determined by measuring the electrical current being drawn by these situations individually or in combination. By way of non-limiting example, a building management system (BMS) can be used to record energy consumption as it relates to a particular setpoint. The set point can then be adjusted according to the methods disclosed herein and the BMS can reevaluate the energy consumption as it relates to the revised setpoint. Generally speaking, the building systems may be allowed a period of time to stabilize, for example, from about 5 minutes to about 120 minutes, such as from about 10 minutes to about 90 minutes, from about 15 minutes to about 60 minutes or from about 20 minutes to about 30 minutes, before the energy consumption is reevaluated. A comparison between the two energy consumption rates can be used to optimize the setpoint for minimum overall energy consumption.

Referring now to FIG. 3, the depicted flowchart illustrates the selection or in situ generation of one or more setpoints by the computer processor, herein referred to as “setpoint mapping.” As previously noted, the setpoint mapping process can either run automatically at a predetermined interval, can be manually initiated by a user, can run automatically when the interior space is either unoccupied or below a predetermined occupancy level, or can run only on certain days, such as weekends or holidays. In step 201, external input I is gathered from the one or more exterior sensors and the computer processor compares the external environmental condition to similar conditions that were previously mapped. For example, if the gathered external input I indicates a sun position (X) at a time of day (Y) on a date (Z1), then the computer processor can search the historical or stored data for similar external environmental conditions, such as a similar sun position (X′) at a similar time of day (Y′) on a different date (Z2). Once the computer processor has selected the appropriate historical or stored setpoint(s), the process can proceed to step 202.

In step 202, one or more of the stored setpoints are applied to the interior space. The setpoint(s) can be applied to the smart window(s) only, e.g., altering the tint level or another physical property of the smart window(s) to adjust light transmission, or to the smart window(s) and at least one additional variable of the interior space, such as artificial lighting, shading, heating, cooling, etc. Once the setpoint is reached, the process can proceed to step 203, in which the computer processor can compare at least one internal environmental condition to the predetermined constraint P stored in the computer processor for this condition.

If the setpoint produces a result meeting the predetermined constraint P, the process can proceed via Y3 to step 205. If the constraint P is not met, the process can either (a) loop back via X4 to step 202 to select another stored setpoint that can be tested to determine if it meets constraint P or (b) proceed via N3 to a mapping step 204 in which multiple iterations of new setpoints are tested and mapped to determine which setpoints meet the predetermined criteria P. It is assumed that during setpoint mapping the external environmental condition is not significantly changing. If there is a substantial change in conditions, then the testing can be restarted and the data collected prior to the change can be removed or partially analyzed for the previous condition. Once a setpoint or subset of setpoints are mapped in step 204, the process can proceed via Y4 to step 205.

In optimization step 205, stored setpoints from step 203 or newly mapped setpoints from step 204 can be further narrowed down to meet additional criteria or predetermined constraints. For instance, additional variables A and their respective constraints can be taken into consideration, such as energy efficiency, occupant comfort, room temperature, and the like. As such, from a given number of setpoints that produce a desired internal environmental condition, such as a desired illuminance or glare level, a single setpoint or a subset of setpoints can be selected that also optimize the additional variable A, for example, thermal heating or cooling load, energy requirements for artificial lighting, room temperature, etc. Once an optimal setpoint or setpoints are chosen, the process can further include reducing the amount of energy supplied to HVAC units and/or artificial lighting. For example, if the occupant desires a clearer outside view, then window setpoints resulting in minimum tint (maximum clarity) can be selected. If energy savings are preferred, setpoints resulting in minimum tint (maximum solar radiation) can be selected in a heating mode or setpoints resulting in maximum tint (minimum solar radiation) can be selected in a cooling mode.

By way of non-limiting example, if a tint level of the smart window(s) can be decreased such that high illuminance is achieved in the interior space without produced undesired levels of glare, then it may be possible to either (a) save energy by dimming the artificial lighting, (b) save energy by reducing the thermal load supplied to the heating system (for cooler temperatures), or (c) both. Similarly, if a tint level of the smart windows can be increased such that low glare is achieved in the interior space while also producing illuminance within a desired range, then it may be possible to save energy by reducing the thermal load supplied to the cooling system (for hotter temperatures).

It should be noted that there are combinatorically a large number of possible subsets of setpoints. For example, an interior space with three overhead lights and four windows, assuming each have four setpoint levels, would result in 74 (2401) potential combinations. Fractional factorial designed experiments can be applied in this situation in which a subset of combinations is tried such that main effects and all or some of the likely second order interactions are captured. Alternatively, the setpoint for each input may be adjusted randomly by a small amount relative to its current setting and the effect observed. This can be useful when the system is operating an optimization scheme to test whether it can be further improved (and, if so, can make small steps in the direction of improvement). Depending on the response time of the windows, as previously discussed, several different setpoints can be tested within a predetermined time period. For example, in the case of liquid crystal windows with a response time of about 1 second or less, up to about 3600 setpoints can be tested within an hour. Of course, the time period can be shorter or longer depending on the desired level of mapping and/or building occupancy.

### Liquid Crystal Windows

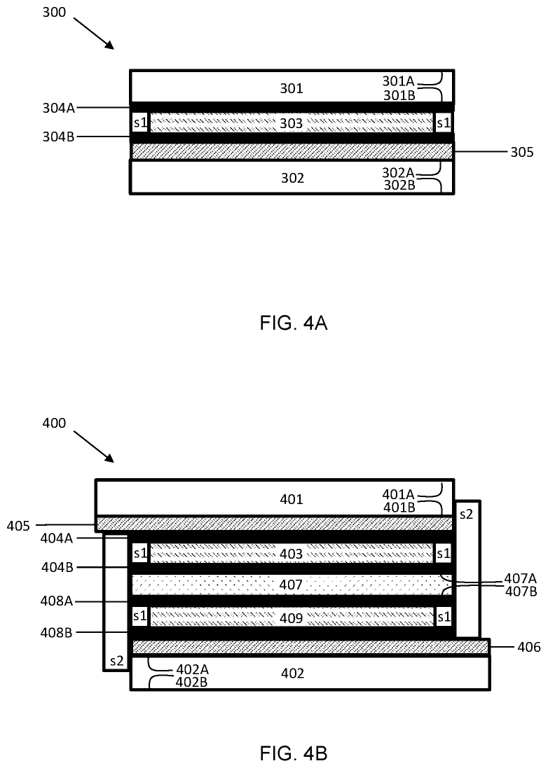

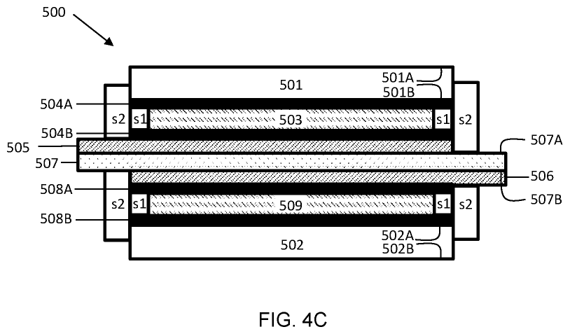

Liquid crystal windows are used in various architectural applications, such as windows, doors, space partitions, and skylights for commercial and residential buildings. Liquid crystal windows can have single cell configurations, double cell configurations, e.g., two side-by-side liquid crystal cell units, or a single cell with interstitial glass (SWIG) configuration. Traditional electrodes can be located on either side of the liquid crystal layer(s) in the window to provide driving voltage for switching the orientation of the liquid crystals. Alternatively, interdigitated electrodes can be located on a single side of the liquid crystal layer(s) for in-plane switching (IPS). FIGS. 4A-C illustrate cross-sectional views of non-limiting embodiments of liquid crystal windows 300, 400, and 500. The liquid crystal windows disclosed herein may comprise a single liquid crystal layer, as depicted in FIG. 4A, or two liquid crystal layers, as depicted in FIGS. 4B-C, or more than two crystal liquid layers (not illustrated).

Referring to FIG. 4A, liquid crystal window 300 includes first substrate 301 having a first (outer) surface 301A and a second (interior) surface 301B and second substrate 302 having a first (interior) surface 302A and second (outer) surface 302B. First and second substrates 301, 302 define a first cell gap that can be filled with liquid crystal material and sealed, e.g., via seals s1, to form first liquid crystal layer 303. Alignment layers 304A-B may be present on opposing sides of the first liquid crystal layer 303, or one or both of the alignment layers may not be present depending on the device design. Interdigitated electrode 305 is formed on and/or in direct contact with one of the interior surfaces of the substrates confining the first liquid crystal layer 303, i.e., second surface 301B of first substrate 301 (not illustrated) or first surface 302A of second substrate 302 (as illustrated in FIG. 4A). In the depicted embodiment, an applied electric field can travel from a higher voltage interdigitated electrode on first surface 302A, loop through first liquid crystal layer 303, and end at a lower voltage interdigitated electrode on surface 302A.

Referring to FIGS. 4B-C, liquid crystal window 400, 500 include first substrates 401, 501 having first (outer) surfaces 401A, 501A and second (interior) surfaces 401B, 501B; second substrates 402, 502 having first (interior) surfaces 402A, 502A and second (outer) surfaces 402B, 502B; and third (interstitial) substrates 407, 507 having first (interior) surfaces 407A, 507A and second (interior) surfaces 407B, 507B. First substrates 401, 501 and third substrates 407, 507 define a first cell gap that can be filled with liquid crystal material and sealed, e.g., via seals s1, to form first liquid crystal layers 403, 503. Second substrates 402, 502 and third substrates 407, 507 define a second cell gap that can be filled with liquid crystal material and sealed, e.g., via seals s1, to form second liquid crystal layers 409, 509. Alignment layers 404A-B, 504A-B may be present on opposing sides of the first liquid crystal layers 403, 503 and alignment layers 408A-B, 508A-B may be present on opposing sides of the second liquid crystal layers 409, 509, or one or more of these alignment layers may not be present depending on the window design.

First interdigitated electrode 405, 505 is formed on and/or in direct contact with one of the interior surfaces of the substrates confining the first liquid crystal layer 403, 503, i.e., second surface 401B of first substrate 401 as depicted in FIG. 4B. The first interdigitated electrode 505 may also be formed on the first surface 507A of third substrate 507 as depicted in FIG. 4C. Similarly, second interdigitated electrode 406, 506 is formed on and/or in direct contact with one of the interior surfaces of the substrates confining the second liquid crystal layer 409, 509, i.e., first surface 402A of second substrate 402 as depicted in FIG. 4B. The second interdigitated electrode 506 may also be formed on the second surface 507B of third substrate 507 as depicted in FIG. 4C.

The substrates 401, 402, 407 and 501, 502, 507 can be arranged, with the third substrate 407, 507 between the first and second substrates 401, 402 and 501, 502 to form two gaps, which can be filled with liquid crystal material to form liquid crystal layers 403, 409 and 503, 509. In some embodiments, spacers (not illustrated) can be used to maintain the desired cell gap and resulting liquid crystal layer thickness. The liquid crystal material can be sealed in the cell gaps around all edges using any suitable material, such as optically or thermally curable resins, to form first seal s1. A second seal s2 can optionally be applied to protect the exposed edges of the substrates and/or electrodes and/or any electrical connections within the device from mechanical impacts and exposure to liquids such as water or condensation.

It is to be understood that the scope of the disclosure is not limited solely to the liquid crystal windows depicted in FIGS. 4A-C. The liquid crystal windows disclosed herein can comprise additional liquid crystal layers, substrates, alignment layers, electrode assemblies, and/or electrode layers, arranged in various different configurations. Some liquid crystal windows may, in certain embodiments, comprise an additional glass substrate, which is separated from the depicted liquid crystal devices by a gap. The additional glass substrate can comprise any suitable glass material having any desired thickness, including those discussed herein with respect to the first, second, and third substrates. The gap can be sealed and filled with air, an inert gas, or a mixture thereof, which may improve the thermal performance of the liquid crystal window. Suitable inert glasses include, but are not limited to, argon, krypton, xenon, and combinations thereof. Mixtures of inert gases or mixtures of one or more inert gases with air can also be used. Exemplary non-limiting inert gas mixtures include 90/10 or 95/5 argon/air, 95/5 krypton/air, or 22/66/12 argon/krypton/air mixtures. Other ratios of inert gases or inert gases and air can also be used depending on the desired thermal performance and/or end use of the liquid crystal window.

In various embodiments, the additional glass substrate is an interior pane, e.g., facing the interior of the building, although the opposite orientation, with glass facing the exterior, is also possible, or both. Liquid crystal windows for use in architectural applications can have any desired dimension including, but not limited to 2′×4′ (width×height), 3′×5′, 5′×8′, 6′×8′, 7×10′, 7′×12′. Larger and smaller liquid crystal windows are also envisioned and are intended to fall within the scope of this disclosure. Although not illustrated, it is to be understood that the liquid crystal windows can comprise one or more additional components such as a frame or other structural component, a power source, and/or a control device or system.

The liquid crystal windows disclosed herein may utilize IPS and can comprise at least one interdigitated electrode assembly. Interdigitated electrodes comprise two coplanar electrodes patterned on the same surface of a substrate, e.g., a substrate defining or confining a liquid crystal layer. Liquid crystal layer(s) can be controlled by interdigitated electrodes, in which an electric field starts at a higher voltage interdigitated electrode, travels through any surrounding media (such as an adjacent liquid crystal layer), and terminates at a lower voltage interdigitated electrode.

The liquid crystal windows disclosed herein can comprise at least one substrate or sheet, such as substrates 301, 302, 401, 402, 407, 501, 502, 507. According to non-limiting embodiments, the substrate(s) may comprise an optically transparent material. As used herein, the term “optically transparent” is intended to denote that the component and/or layer has a transmission of greater than about 80% in the visible region of the spectrum (˜400-700 nm). For instance, an exemplary component or layer may have greater than about 85% transmittance in the visible light range, such as greater than about 90%, or greater than about 92%, including all ranges and subranges therebetween. In certain embodiments, all of the substrates in the disclosed windows comprise an optically transparent material.

In non-limiting embodiments, the substrate(s) may comprise optically transparent glass sheets. According to other embodiments, the substrate(s) may comprise a material other than glass, such as plastics and ceramics, including glass ceramics. Suitable plastic materials include, but are not limited to, polycarbonates, polyacrylates such as polymethylmethacrylate (PMMA), and polyethyelenes such as polyethylene terephthalate (PET). The substrate(s) can have any shape and/or size, such as a rectangle, square, or any other suitable shape, including regular and irregular shapes and shapes with one or more curvilinear edges. According to various embodiments, the substrate(s) can have a thickness of less than or equal to about 4 mm, for example, ranging from about 0.005 mm to about 4 mm, from about 0.01 mm to about 3 mm, from about 0.02 mm to about 2 mm, from about 0.05 mm to about 1.5 mm, from about 0.1 mm to about 1 mm, from about 0.2 mm to about 0.7 mm, or from about 0.3 mm to about 0.5 mm, including all ranges and subranges therebetween. In certain embodiments, the substrate(s) can have a thickness of less than or equal to 0.5 mm, such as 0.4 mm, 0.3 mm, 0.2 mm, 0.1 mm, 0.05 mm, 0.02 mm, 0.01 mm, or 0.005 mm, including all ranges and subranges therebetween. In non-limiting embodiments, the substrate(s) can have a thickness ranging from about 1 mm to about 3 mm, such as from about 1.5 to about 2 mm, including all ranges and subranges therebetween.

The substrate(s) may comprise any glass known in the art, for example, soda-lime silicate, aluminosilicate, alkali-aluminosilicate, borosilicate, alkaliborosilicate, aluminoborosilicate, alkali-aluminoborosilicate, and other suitable display glasses. The substrate(s) may, in some embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

According to various embodiments, the substrate(s) may be chosen from glass sheets produced by a fusion draw process. Without wishing to be bound by theory, it is believed that the fusion draw process can provide glass sheets with a relatively low degree of waviness (or high degree of flatness), which may be beneficial for various liquid crystal applications. An exemplary glass substrate may thus, in certain embodiments, comprise a surface waviness of less than about 100 nm as measured with a contact profilometer, such as about 80 nm or less, about 50 nm or less, about 40 nm or less, or about 30 nm or less, including all ranges and subranges therebetween. An exemplary standard technique for measuring waviness (0.8˜8 mm) with a contact profilometer is outlined in SEMI D15-1296 “FPD Glass Substrate Surface Waviness Measurement Method.” According to further embodiments, the substrate(s) or sheet(s) may comprise a highly conductive transparent material, for instance, a material having an electrical conductivity of at least about 10⁻⁵ S/m, at least about 10⁻⁴ S/m, at least about 10⁻³ S/m, at least about 10⁻² S/m, at least about 0.1 S/m, at least about 1 S/m, at least about 10 S/m, or at least about 100 S/m, e.g., ranging from 0.0001 S/m to about 1000 S/m, including all ranges and subranges therebetween.

The liquid crystal windows disclosed herein can comprise at least one interdigitated electrode and one or more bus bars connecting the interdigitated electrodes. Interdigitated electrodes and bus bars can comprise the same or different conductive materials. Suitable conductive materials can comprise one or more transparent conductive oxides (TCOs), such as indium tin oxide (ITO), indium zinc oxide (IZO), gallium zinc oxide (GZO), aluminum zinc oxide (AZO), and other like materials. Alternatively, other transparent materials, such as a conductive mesh, e.g., comprising metals such as silver nanowires or other nanomaterials such as graphene or carbon nanotubes can be used. Printable conductive ink layers such as ActiveGrid™ from C3Nano Inc. may also be used. Combinations of materials can also be used. The thickness of each interdigitated electrode or bus bar can, for example, independently range from about 1 nm to about 1000 nm such as from about 5 nm to about 500 nm, from about 10 nm to about 300 nm, from about 20 nm to about 200 nm, from about 30 nm to about 150 nm, or from about 50 nm to about 100 nm, including all ranges and subranges therebetween. According to various embodiments, the sheet resistance (e.g., as measured in ohms-per-square) of the interdigitated electrodes and/or bus bars can range from about 10Ω/□ (ohms/square) to about 1000Ω/□, such as from about 50Ω/□ to about 900Ω/□, from about 100Ω/□ to about 800Ω/□, from about 200Ω/□ to about 700Ω/□, from about 300Ω/□ to about 600Ω/□, or from about 400Ω/□ to about 500Ω/□, including all ranges and subranges therebetween. The individual electrodes and bus bars present in the disclosed assemblies and devices may comprise the same or different materials, the same or different thicknesses, and the same or different patterns.

In some embodiments, the liquid crystal windows disclosed herein can comprise one or more alignment layers. The individual alignment layers present in the liquid crystal windows may, in some embodiments, comprise the same or different materials, the same or different thicknesses, and the same or different orientations relative to one another. Alignment layers can comprise a thin film of material having a surface energy and anisotropy promoting the desired orientation for the liquid crystals in direct contact with its surface. Exemplary materials include, but are not limited to, main chain or side chain polyimides, which can be mechanically rubbed to generate layer anisotropy; photosensitive polymers, such as azobenzene-based compounds, which can be exposed to linearly polarized light to generate surface anisotropy; and inorganic thin films, such as silica, which can be deposited using thermal evaporating techniques to form periodic microstructures on the surface.

According to various embodiments, the alignment layers can have a thickness of less than or equal to about 100 nm, for example, ranging from about 1 nm to about 100 nm, from about 5 nm to about 90 nm, from about 10 nm to about 80 nm, from about 20 nm to about 70 nm, from about 30 nm to about 60 nm, or from about 40 nm to about 50 nm, including all ranges and subranges therebetween.

In additional embodiments, the liquid crystal windows disclosed herein can comprise at least one liquid crystal layer disposed between at least two substrates, for example, one liquid crystal layer defined by two substrates, or two liquid crystal layers defined three substrates. The individual liquid crystal layers in the device may comprise the same or different liquid crystal materials and/or additives, the same or different thicknesses, the same or different switching modes, and the same or different orientations relative to one another.

A liquid crystal layer can comprise liquid crystals and one or more additional components, such as dyes or other coloring agents, chiral dopants, polymerizable reactive monomers, photoinitiators, polymerized structures, or any combination thereof. The liquid crystals can have any liquid crystal phase, such as achiral nematic liquid crystal (NLC), chiral nematic liquid crystal, cholesteric liquid crystal (CLC), or smectic liquid crystal, which are operable over a broad range of temperatures, such as from about −40° C. to about 110° C.

According to various embodiments, the liquid crystal layers can comprise a cell gap or cavity that is filled with liquid crystal material. The thickness of the liquid crystal layer, or the cell gap distance, can be maintained by particle spacers and/or columnar spacers dispersed in the liquid crystal layer. The liquid crystal layers can have a thickness of less than or equal to about 0.2 mm, for example, ranging from about 0.001 mm to about 0.1 mm, from about 0.002 mm to about 0.05 mm, from about 0.003 mm to about 0.04 mm, from about 0.004 mm to about 0.03 mm, from about 0.005 mm to about 0.02 mm, or from about 0.01 mm to about 0.015 mm, including all ranges and subranges therebetween. The individual liquid crystal layers in the device may all comprise the same thickness, or may have different thicknesses.

The substrates in the liquid crystal window can have a surface energy promoting the desired alignment of the liquid crystal director in a ground or “off” state without applied voltage. A vertical or homeotropic alignment is achieved when the liquid crystal director has a perpendicular or substantially perpendicular orientation with respect to the plane of the substrate. A planar or homogeneous alignment is achieved when the liquid crystal director has a parallel or substantially parallel orientation with respect to the plane of the substrate. An oblique alignment is achieved when the liquid crystal direction has a large angle with respect to the plane of the substrate, which is substantially different from planar or homeotropic, i.e., ranging from about 20° to about 70°, such as from about 30° to about 60°, or from about 40° to about 50°, including all ranges and subranges therebetween.

In some embodiments, dyes or other coloring agents, such as dichroic dyes, can be added to one or more of the liquid crystal layers to absorb light transmitted through the liquid crystal layer(s). Dichroic dyes typically absorb light more strongly along a direction parallel to the direction of a transition dipole moment in the dye molecule, which is typically the longer molecular axis of the dye molecule. Dye molecules oriented with their long axis perpendicular to the direction of light polarization will provide low light attenuation, whereas dye molecules oriented with their long axis parallel to the direction of light polarization will provide strong light attenuation.

One or more chiral dopants may be added to the liquid crystal mixture to form highly twisted cholesteric liquid crystals (CLC), which may have a random alignment that provides light scattering effects, referred to herein as a focal conic texture. Random liquid crystal alignment can also be promoted or assisted by including polymer structures, such as polymer fibers, in the matrix of the liquid crystal layer, referred to herein as polymer stabilized cholesteric texture (PSCT). Random liquid crystal alignment can also be achieved using small droplets of nematic liquid crystal (without a chiral dopant) randomly dispersed in a solid polymer layer or a dense network of polymer fibers, or polymer walls, referred to herein as polymer dispersed liquid crystal (PDLC).

According to various embodiments, polymers may be dispersed in the matrix of the liquid crystal layer or on the interior surfaces of the glass and interstitial substrates. Such polymers may be formed by polymerization of monomers dissolved in the liquid crystal mixture. In certain embodiments, polymer protrusions or other polymerized structures may be formed on the interior surfaces of the outer substrates and/or interstitial substrates, such as in a normally clear liquid crystal window with homeotropic alignment layer(s), to define an azimuthal switching direction and to improve electro-optic switching speed.

As noted above, chiral dopants may be added to the liquid crystal mixture to achieve a twisted supramolecular structure of liquid crystal molecules, referred to herein as cholesteric liquid crystal (CLC). The amount of twist in the CLC is described by a helical pitch which represents the rotation angle of a local liquid crystal director by 360 degrees across the cell gap thickness. CLC twist can also be quantified by a ratio (d/p) of cell gap thickness (d) to CLC helical pitch (p). For liquid crystal applications, the amount of chiral dopant dissolved in the liquid crystal mixture can be controlled to achieve a desired amount of twist across a given cell gap distance. It is within the ability of one skilled in the art to select the appropriate dopant and its amount to achieve the desired twisted effect.

In various embodiments, the liquid crystal layers disclosed herein may have an amount of twist ranging from about 0° to about 25×360° (or d/p ranging from about 0 to about 25.0), for example, ranging from about 45° to about 1080° (d/p from about 0.125 to about 3), from about 90° to about 720° (d/p from about 0.25 to about 2), from about 180° to about 540° (d/p from about 0.5 to about 1.5), or from about 270° to about 360° (d/p from about 0.5 to about 1), including all ranges and subranges therebetween. As used herein, a liquid crystal mixture that does not include chiral dopants is referred to as a nematic liquid crystal (NLC). A liquid crystal that includes a chiral dopant and has a small pitch and a large twist refers to a CLC mixture wherein d/p is greater than 1. A liquid crystal that includes a chiral dopant and has a large pitch and a small twist refers to a CLC mixture wherein d/p is less than or equal to 1.

### EXAMPLES

### Example 1

The following prophetic example illustrates a non-limiting example of setpoint mapping of at least one environmental condition for an interior space using the methods and apparatuses disclosed herein. All values provided below are exemplary only, are not empirical values, and are not intended to be limiting on the scope of the disclosure.

Assumptions: (1) a room R as depicted in FIGS. 1A-C in a building equipped with a BMS, wherein window W1 faces east and window W2 faces north; (2) BMS constraints for room R as follows: (i) illumination 300-600 lux; (ii) glare DGI≤22; and (iii) room temperature 68-72° F. (20-22° C.); (3) no occupancy in room R; (4) setpoint mapping scheduled 6 times per minute (every 10 seconds) from 6 am to 9 pm on Sunday, Sep. 5, 2021.

The first timepoint for setpoint mapping begins at or around when the sun rises, e.g., 6 am. Until around noon, the sun will directly impact window W1 and light will also enter window W2 to a more limited extent. After noon, the sun has less of a direct impact on window W1. External sensors can determine the time of year, sun position, cloudiness, fogginess, rain, or other weather-related impacts at a given timepoint. Internal sensors can take measurements for each of illuminance, glare, and/or room temperature at each timepoint.

As the external conditions change at each setpoint, at least one property of window W1 and/or W2 can be adjusted to account for the changes in, e.g., sun position, cloudiness, weather patterns, and the like. Adjustments can include, for example, increasing or decreasing tint level, increasing or decreasing contrast level, increasing, and/or decreasing light scattering (window opacity). Adjustments are made to ensure that some or all of constraints (i)-(iii) are met during the setpoint mapping period. Each of the readings from the external sensors, internal sensors, and the related setpoints can be recorded by the computer processing unit to form a look up table or map that can be accessed for future reference. A simplified look up table is provided below solely for the sake of example.

TABLE I
Look Up Table

| | | | | ILLUMI- | |
|---|---|---|---|---|---|
| SETPOINT | DAY | TIME | CONDITION | NANCE | GLARE |
| 1 | 5 Sep. | 6:00 | Hazy | 390 | 19 |
| | 2021 | | | | |
| 2 | 5 Sep. | 7:00 | Sunny | 420 | 21 |
| | 2021 | | | | |
| 3 | 5 Sep. | 8:00 | Partly Cloudy | 430 | 20 |
| | 2021 | | | | |
| 4 | 5 Sep. | 9:00 | Partly Cloudy | 450 | 20 |
| | 2021 | | | | |

### Example 2

The following prophetic example illustrates a non-limiting example of using historical setpoint data to adjust at least one environmental condition of an interior space using the methods and apparatuses disclosed herein. All values provided below are exemplary only, are not empirical values, and are not intended to be limiting on the scope of the disclosure.

Assumptions: (1) setpoint mapping in room R as per Example 1; (2) BMS constraints as per Example 1; (3) setpoint adjustment scheduled 6 times per hour (every 10 minutes) on Monday, Sep. 6, 2021.

The adjustment process can occur prior to occupancy of room R or when the room occupancy is below a given threshold. External sensors can determine the time of year, sun position, cloudiness, fogginess, rain, or other weather-related impacts at the chosen time point. The computer processor can reference the look up table from previously performed mapping and determine an initial setpoint that corresponds to similar external environmental conditions at a similar timepoint. If, for example, it is sunny at 8 am on Monday, Sep. 6, 2021, the computer processor can search for similar external environmental condition data from Sunday, Sep. 5, 2021 setpoint mapping. Examples can include, but are not limited to, setpoint mapping performed during sunny conditions at or around 8 am on Sunday, Sep. 5, 2021. As more setpoint mapping is performed, more data points will be stored and accessible to the computer processor.

A starting setpoint can be chosen from the historical data that is most likely to result in meeting the constraints set for room R. At least one of windows W1 and/or W2 can be adjusted according to the stored (starting) setpoint. Internal sensors can then take measurements for each of illuminance, glare, and/or room temperature to ensure that the constraints are met using the stored setpoint. If the desired constraints are met, further changes may not be required. If the constraints are not met, another stored setpoint may be tried or new setpoint mapping can begin.

For example, at 8 am on Monday, Sep. 6, 2021, external sensors may indicate sunny conditions and starting setpoint 2 can be chosen from historical data at 7 am on Sunday, Sep. 5, 2021 when similarly sunny conditions exist. On Sunday at 7 am, setpoint 2 results in an illuminance level of 420 lux and a glare DGI=21. However, on Monday at 8 am, the same setpoint results in an illuminance level of 440 lux and a glare DG1 of 22.5. See Table II below. While the illuminance levels meet the constraint of the BMS, the glare level is now outside of the maximum desired threshold, e.g., due to additional direct sunlight entering window W1. Because the BMS constraints are not met, another stored setpoint can be tried. For instance, setpoint 3 may be chosen from historical data on Sunday at 8 am when partly cloudy conditions exist. On Sunday at 8 am, the setpoint 3 results in an illuminance level of 430 lux and a glare DGI=20. However, on Monday at 8 am, the same setpoint results in an illuminance level of 450 lux and a glare DG1 of 21. Both BMS constraints are met using this stored setpoint and further adjustment may not be required.

TABLE II
Setpoint Adjustment

| | | | | ILLUMI- | |
|---|---|---|---|---|---|
| SETPOINT | DAY | TIME | CONDITION | NANCE | GLARE |
| 2 | 5 Sep. | 7:00 | Sunny | 420 | 21 |
| | 2021 | | | | |
| 2 | 6 Sep. | 8:00 | Sunny | 440 | 22.5 |
| | 2021 | | | | |
| 3 | 5 Sep. | 8:00 | Partly Cloudy | 430 | 20 |
| | 2021 | | | | |
| 3 | 6 Sep. | 8:00 | Sunny | 450 | 21 |
| | 2021 | | | | |

### Example 3

The following prophetic example illustrates a non-limiting example of optimizing at least one constraint on an environmental condition of an interior space using the methods and apparatuses disclosed herein. All values provided below are exemplary only, are not empirical values, and are not intended to be limiting on the scope of the disclosure.

Assumptions: (1) setpoint mapping in room R as per Example 1; (2) BMS constraints as per Example 1; (3) setpoint adjustment scheduled 3 times per minute (every 20 seconds); (4) initial timepoint: 9 am on Monday, Sep. 6, 2021, partly cloudy; (5) starting setpoint 4: illuminance level=450 lux; glare DGI=20.

This prophetic example illustrates the ability of the apparatuses and methods disclosed herein to potentially further optimize a setpoint that meets BMS constraints. In Example 1, setpoint 4 meets BMS constraints (illuminance=450 lux; glare DGI=20) on Sunday, Sep. 5, 2021 at 9 am. The same values are obtained using setpoint 4 on Monday, Sep. 6, 2021 at 9 am. See Table III. While these conditions are acceptable for room R, additional incremental adjustments can be carried out to optimize one or more constraints on environmental conditions in the room. For example, it might be possible to adjust at least one property of window W1 and/or W2 to maximize illuminance in the room without negatively impacting glare. The glare value may stay the same, may decrease or, in some cases, may increase but remain within acceptable constraints. Similarly, it might be possible to adjust at least one property of window W1 and/or W2 to minimize glare in the room without negatively impacting illuminance. For instance, the illuminance level may stay the same, may decrease or, in some cases, may increase but remain within acceptable constraints.

Referring to Table III below, starting from historical setpoint 4, decreasing the tint on window W2 using setpoint 4A can provide an improved illuminance of 500 lux while not changing the glare in the room (DGI=20). Decreasing the tint on window W2 while also increasing the tint on window W1 using setpoint 4B can provide an improved illuminance of 480 lux while also lowering the glare in the room (DGI=19). Decreasing the tint on both windows W1 and W2 can provide an improved illuminance of 540 lux, but will also increase the glare in the room (DG1=21). However, the glare level is still within acceptable constraints and may thus be operable to optimize illuminance in the room. Each of setpoints 4A-C can be rapidly tested, e.g., within a minute, and the choice between setpoints 4A-C can vary depending on the prioritization of illuminance over glare or vice versa.

TABLE III
Setpoint Optimization

| | | | | ILLUMI- | |
|---|---|---|---|---|---|
| SETPOINT | DAY | TIME | CONDITION | NANCE | GLARE |
| 4 | 5 Sep. | 9:00 | Partly Cloudy | 450 | 20 |
| | 2021 | | | | |
| 4 | 6 Sep. | 9:00 | Partly Cloudy | 450 | 20 |
| | 2021 | | | | |
| 4A | 6 Sep. | 9:01 | Partly Cloudy | 500 | 20 |
| | 2021 | | | | |
| 4B | 6 Sep. | 9:01 | Partly Cloudy | 480 | 19 |
| | 2021 | | | | |
| 4C | 6 Sep. | 9:01 | Partly Cloudy | 540 | 21 |
| | 2021 | | | | |

### Example 4

The following prophetic example illustrates a non-limiting example of optimizing at least one secondary variable of the interior space while also satisfying the constraints on environmental conditions using the methods and apparatuses disclosed herein. All values provided below are exemplary only, are not empirical values, and are not intended to be limiting on the scope of the disclosure.

Assumptions: (1) setpoint mapping in room R as per Example 1; (2) BMS constraints as per Example 1; (3) setpoint adjustment in room R as per Example 2; (4) initial timepoint: 9 am on Monday, Sep. 6, 2021, partly cloudy; (5) starting setpoint 4: illuminance level=450 lux; DGI=20.

This prophetic example illustrates the ability of the apparatuses and methods disclosed herein to optimize a secondary variable for a starting setpoint meeting BMS constraints. In the example listed above, a setpoint has been chosen at that meets BMS constraints (illuminance=450 lux; glare DGI=20). While these conditions are acceptable for room R, it may be desirable to also optimize a secondary variable of the interior space within the BMS constraints. Here, we will evaluate optimization of energy efficiency in terms of reducing energy expended on artificial interior lighting.

Starting from setpoint 4 (illuminance=450 lux; DGI=20; artificial lighting=60%; window tint=20%), it can be possible to reduce artificial lighting in room R to reduce the overall energy consumption of the interior space. Referring to Table IV, at setpoint 4D the artificial lighting level in room R can be reduced by 10% (from 60% to 50%) while retaining the same window tint settings. This results in an overall lower illuminance level (410 lux as compared to 450 lux) but this value is still within the BMS constraints and can provide up to a 20% cost savings in terms of energy consumption by artificial lighting in room R. Setpoint 4E can also be tried, in which the artificial lighting is similarly reduced by 10% but the window tint level is also reduced by 5% (from 20% to 15%) to compensate for the reduced artificial lighting. This results in an improved illuminance level when compared to setpoint 4D (430 lux as compared to 410 lux) but also increases the glare in the room to DGI=21. However, the glare level is still within the BMS constraints and can provide a 20% cost savings in terms of energy consumption by artificial lighting as compared to setpoint 4 without affecting the illuminance level as greatly as setpoint 4D.

TABLE IV
Artificial Lighting Optimization

| SETPOINT | DAY | TIME | LIGHTING | TINT | ILLUMINANCE | GLARE |
|---|---|---|---|---|---|---|
| 4 | 6 SEP. 2021 | 9:00 | 50% | 20% | 450 | 20 |
| 4D | 6 SEP. 2021 | 9:10 | 40% | 20% | 410 | 20 |
| 4E | 6 SEP. 2021 | 9:20 | 40% | 15% | 430 | 21 |

### Example 5

The following prophetic example illustrates a non-limiting example of optimizing at least one secondary variable of the interior space while also satisfying the constraints on environmental conditions using the methods and apparatuses disclosed herein. All values provided below are exemplary only, are not empirical values, and are not intended to be limiting on the scope of the disclosure.

Assumptions: (1) setpoint mapping in room R as per Example 1; (2) BMS constraints as per Example 1; (3) setpoint adjustment in room R as per Example 2; (4) initial timepoint: 9 am on Monday, Sep. 6, 2021, partly cloudy; (5) starting setpoint 4: illuminance level=450 lux; DGI=20.

Similar to Example 4, this prophetic example illustrates the ability of the apparatuses and methods disclosed herein to optimize a secondary variable for a starting setpoint meeting BMS constraints. Here, we will evaluate optimization of energy efficiency in terms of reducing energy expended on heating or cooling.

Starting from setpoint 4 (illuminance=450 lux; DGI=20; target room temperature=70° F. (21° C.); window tint=20%; HVAC efficiency=80%), it is possible to reduce light transmission through window W1 and/or W2, which in turn reduces the energy consumption due to air conditioning of the interior space. Referring to Table V, at setpoint 4F the tint level on one or both of windows W1, W2 is increased by 5% (from 20% to 25%). The increased tint will reduce the solar heat gain coefficient (SHGC) of the window(s) and thereby result in less solar heat transmitted into the room R. This results in an overall lower illuminance level (400 lux as compared to 450 lux) but this value is still within the BMS constraints and can provide a 3% cost savings in terms of energy consumption by HVAC systems in room R. Setpoint 4G can also be tried, in which the tint level on one or both of windows W1, W2 is increased by 5% and the window treatments (blinds, drapes, shades) are also adjusted (e.g., adjusting blind tilt, partially closing or drawing shades or drapery, etc.) to further improve HVAC efficiency to 85%. This may result in lower illuminance (380 lux) but this value is still within BMS constraints and has the added advantage of reduced glare (DGI=17).

TABLE V
HVAC Optimization

| SETPOINT | DAY | TIME | HVAC EFF | TINT | ILLUMINANCE | GLARE |
|---|---|---|---|---|---|---|
| 4 | 6 SEP. 2021 | 9:00 | 80% | 20% | 450 | 20 |
| 4F | 7 SEP. 2021 | 9:00 | 83% | 25% | 400 | 18 |
| 4G | 8 SEP. 2021 | 9:00 | 85% | 25% | 380 | 17 |

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device or method that comprises A+B+C include embodiments where a device or method consists of A+B+C and embodiments where a device or method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A method for controlling at least one environmental condition of an interior space comprising at least one window, the method comprising:
(a) receiving a first indication of at least one external environmental condition from at least one exterior sensor at a first timepoint;
(b) receiving a second indication of the at least one external environmental condition from the at least one exterior sensor at a second timepoint;
(c) determining a change in the at least one external environmental condition between the first timepoint and a second timepoint;
(d) receiving an indication of at least one internal environmental condition in the interior space from at least one interior sensor at the second timepoint;
(e) determining if the at least one internal environmental condition satisfies at least one predetermined constraint at the second timepoint; and
(f) altering a light transmission of the at least one window using a control device configured to adjust at least one physical property of the at least one window to produce a setpoint,
wherein the at least one internal environmental condition satisfies the at least one predetermined constraint at the setpoint.

2. The method of claim 1, wherein the at least one window comprises a liquid crystal window and wherein altering the light transmission of the at least one window comprises actuating at least one liquid crystal layer in the liquid crystal window.

3. The method of claim 1, wherein the at least one external environmental condition is chosen from time of day, time of year, season, geographical position, sun position, sun intensity, cloudiness, fogginess, haze level, temperature, humidity, or combinations thereof.

4. The method of claim 1, wherein the at least one internal environmental condition is chosen from illuminance, glare, room temperature, or combinations thereof.

5. The method of claim 1, wherein the control device adjusts at least one of a tint level, contrast level, or light scattering property of the at least one window.

6. The method of claim 1, further comprising receiving a room occupancy indicator from the at least one interior sensor prior to altering the light transmission of the at least one window.

7. The method of claim 6, wherein altering the light transmission of the at least one window occurs when the at least one interior sensor indicates that an occupancy of the interior space is less than or equal to a predetermined occupancy threshold.

8. The method of claim 1, wherein altering the light transmission of the at least one window comprises selecting a setpoint from stored setpoints determined at previous timepoints during external environmental conditions similar to the at least one external environmental condition determined at the second timepoint.

9. The method claim 1, comprising repeating steps (d)-(f) in situ for a predetermined time period to produce a plurality of possible setpoints and selecting an optimal setpoint corresponding to a maximum or minimum value of the at least one internal environmental condition.

10. The method of claim 1, further comprising adjusting at least one of a position of external or internal blinds, shades, or drapery; artificial light intensity; room temperature, or combinations thereof using the at least one control device.

11. The method of claim 1, wherein the at least one internal environmental condition comprises a first internal environmental condition and a second internal environmental condition, and the method further comprises:
(g) altering at least one additional variable of the interior space using the at least one control device to produce an overall setpoint,
wherein the first internal environmental condition satisfies a first predetermined constraint and the second internal environmental condition satisfies a second predetermined constraint at the overall setpoint.

12. The method of claim 11, further comprising repeating steps (d)-(g) in situ for a predetermined time period to produce a plurality of possible setpoints and selecting an optimal setpoint corresponding to a maximum or minimum value of the first internal environmental condition, wherein the second internal environmental condition satisfies the second predetermined constraint at the optimal setpoint.

13. The method of claim 1, wherein altering the light transmission of the at least one window occurs within an adjustment time period of 15 seconds or less.

14. The method of claim 13, wherein the adjustment time period is 1 second or less.

15. An apparatus for controlling at least one environmental condition of an interior space, the apparatus comprising:
(a) at least one exterior sensor configured to determine at least one external environmental condition;
(b) at least one interior sensor configured to determine at least one internal environmental condition;
(c) a computer processor configured to receive data from the at least one exterior sensor and the at least one interior sensor and to determine at least one setpoint based on the received data;
(d) a control device in communication with the computer processor and configured to receive the at least one setpoint and send a signal with adjustment instructions to at least one window; and
(e) at least one window configured to receive the signal and to actuate upon receipt of the signal to adjust at least one physical property of the at least one window based on the adjustment instructions within an adjustment time period of 15 seconds or less.

16. The apparatus of claim 1, wherein the adjustment time period is 1 second or less.

17. The apparatus of claim 15, wherein the at least one window is a liquid crystal window.

18. The apparatus of claim 15, wherein the at least one physical property is chosen from one or more of light transmission, light scattering, tint level, and contrast level of the at least one window.

19. The apparatus of claim 15, wherein the at least one exterior sensor is chosen from visible light sensors, infrared sensors, temperature sensors, humidity sensors, or combinations thereof.

20-26. (canceled)
